(19) United States
(12) Patent Application Publication
(10) Pub. No.: US 2009/0001177 A1
(43) Pub. Date: Jan. 1, 2009

(54) STORED-VALUE VESSEL

(75) Inventors: David B. SMITH, Falcon Heights, MN (US); John DWYER, Oak Park Heights, MN (US)

Correspondence Address: TARGET BRANDS, INC., 1000 NICOLLET MALL, TPS-3165, MINNEAPOLIS, MN, 55403, US

(73) Assignee: TARGET BRANDS, INC., MINNEAPOLIS, MN (US)

(21) Appl. No.: 12/124,422

(22) Filed: May 21, 2008

Related U.S. Application Data
(60) Provisional application No. 60/947,047, filed on Jun. 29, 2007.

(51) Int. Cl. G06K 19/067; G06K 19/06; G06Q 20/00

(52) U.S. Cl. 235/494; 235/493; 235/492; 705/39

(57) ABSTRACT

A stored-value vessel includes an end wall, a side wall, and an account identifier. The side wall extends around and away from the end wall to define a chamber therebetween. The chamber is configured to repeatedly receive one or more products for consumption by a bearer of the stored-value vessel. The account identifier is machine readable by a point-of-sale terminal and immovably included on at least one of the end wall and the side wall. The account identifier links the stored-value vessel to an account or record such that the stored-value vessel is configured to facilitate use of the stored-value vessel as one of payment toward a purchase of one or more of goods and services and an inventory tracking mechanism. Related vessels, cups and associated methods are also disclosed and provide additional advantages.

### CROSS-REFERENCE TO RELATED APPLICATION

This application claims the benefit of U.S. Provisional Application No. 60/947,047, filed Jun. 29, 2007.

### BACKGROUND OF THE INVENTION

Stored-value cards and other transaction cards come in many forms. A gift card, for example, is a type of stored-value card that includes a pre-loaded or selectively loaded monetary value. In one example, a consumer buys a gift card having a specified value for presentation as a gift to another person. In another example, a consumer is offered a gift card as an incentive to make a purchase. A gift card, like other stored-value cards, can be “recharged” or “reloaded” at the direction of the bearer. The balance associated with the gift card declines as the gift card is used, encouraging repeat visits to the merchant or other provider issuing the gift card. Additionally, the gift card generally remains in the user's purse or wallet, serving as an advertisement or reminder to revisit the associated merchant. Gift cards and other stored-value cards provide a number of advantages to both the consumer and the merchant.

### SUMMARY OF THE INVENTION

One aspect of the present invention relates to a stored-value vessel including an end wall, a side wall, and an account identifier. The side wall extends around and away from the end wall to define a chamber therebetween, wherein the chamber is configured to repeatedly receive one or more products for consumption by a bearer of the stored-value vessel. The account identifier is machine readable by a point-of-sale terminal and immovably included on at least one of the end wall and the side wall. The account identifier links the stored-value vessel to an account or record such that the stored-value vessel is configured to facilitate use of the stored-value vessel as one of payment toward a purchase of one or more of goods and services and an inventory tracking mechanism. Transaction cups, associated methods, and other embodiments of stored-value vessels are also disclosed.

### BRIEF DESCRIPTION OF THE DRAWINGS

Embodiments of the invention will be described with respect to the figures, in which like reference numerals denote like elements, and in which:

FIG. 1 illustrates a perspective view of a stored-value vessel, according to one embodiment of the present invention.

FIG. 2 illustrates a bottom view of the stored-value vessel of FIG. 1, according to one embodiment of the present invention.

FIG. 3 illustrates a front view of a label of the stored-value vessel of FIG. 1, according to one embodiment of the present invention.

FIG. 4 is a flow chart illustrating a method of forming a stored-value vessel, according to one embodiment of the present invention.

FIG. 5 is a flow chart illustrating a method of encouraging purchase and facilitating use of a stored-value vessel, according to one embodiment the present invention.

FIG. 6 is a flow chart illustrating a method of using a stored-value vessel, according to one embodiment of the present invention.

### DETAILED DESCRIPTION

The following detailed description of the invention is merely exemplary in nature and is not intended to limit the invention or the application and uses of the invention. Furthermore, there is no intention to be bound by any theory presented in the preceding background of the invention or the following detailed description of the invention.

A financial transaction or stored-value vessel is adapted to facilitate payment toward the purchase of goods and/or services at a merchant, for example, a retail store or web site. In one example, the stored-value vessels functions similarly to a stored-value card such as a gift card, prepaid card, etc. and, therefore, is linked to an associated financial account or record having an associated balance of funds or other value available for use toward one or more purchases. In addition, the stored-value vessel is configured to be filled and re-filled with a beverage or other consumable of the consumer's choice. In one example, a retail store, which sells the desired consumable, is adapted to conveniently accept the stored-value vessel as payment toward the purchase of the consumable and to fill the stored-value vessel with the consumable being purchased. As such, a consumer need not search out a payment vehicle separate from the vessel for receiving the consumable.

By providing a single product that is both a payment vehicle and a usable container for consumables, consumer convenience is greatly increased. More specifically, not only is the consumer relieved of the task of seeking out cash, credit card, debit card, or other form of payment from her pockets, purse, wallet, etc., but since fewer items need be exchanged between the merchant and the consumer during a purchase, the purchase or transaction time is decreased, which benefits both the consumer and the merchant. In addition, in one embodiment, additional value can continually or periodically be loaded to the stored-value vessel, encouraging repeated use of the sustainable stored-value vessel in receiving a consumable. In turn, repeated use of the stored-value vessel contributes to the health and welfare of the environment as a whole by decreasing the amount of waste generated as compared one-time use of disposable contains to received purchased consumables.

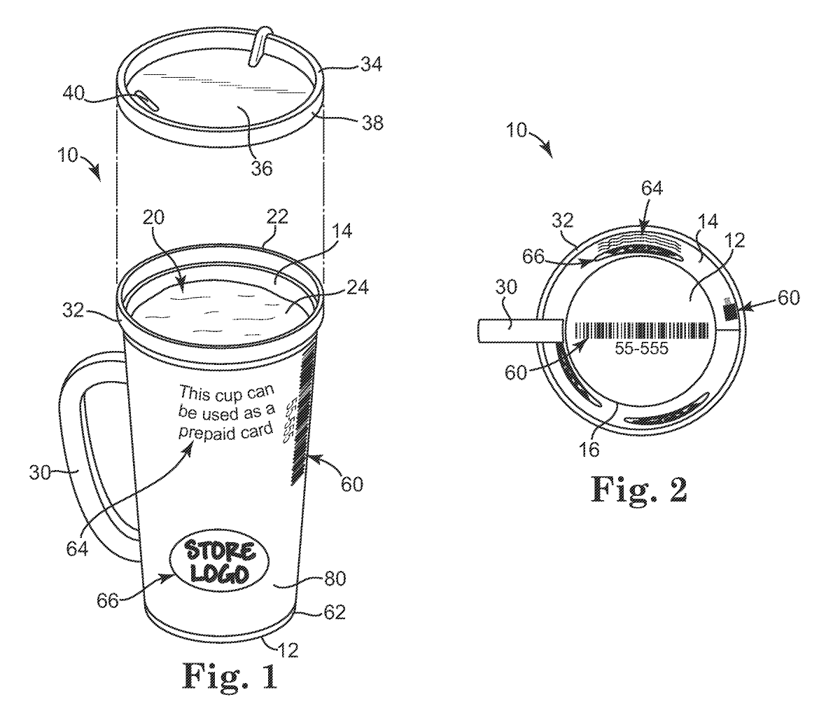

Turning to the figures, FIGS. 1 and 2 respectively illustrate a perspective view and a bottom view of one embodiment of a financial or stored-value product, more specifically, a stored-value vessel 10. Stored-value vessel 10 assumes any of a wide variety of forms, including the form depicted in FIGS. 1 and 2, as will be apparent to those of skill in the art upon reading the present application. In one embodiment, stored-value vessel 10 is substantially in the shape of a cup (e.g., a drinking cup) and includes an end wall 12 and a side wall 14.

End wall 12 is shaped in any suitable manner, and in one example, is substantially circular. Side wall 14 extends about and outwardly away from a perimeter 16 of end wall 12. In one embodiment, side wall 14 is cylindrical, frustoconical, or is otherwise closed on itself to create a compartment or chamber 20 on one side of end wall 12. In one example, side wall 14 outwardly tapers as side wall 14 extends further away from end wall 12. An opening 22 to chamber 20 is formed by side wall 14 opposite end wall 12. As such, beverage products or other consumables 24 (e.g., edible or otherwise digestible products) can be placed within and/or removed from chamber 20 through opening 22. As such, in one example, chamber 20 is sized to receive a suitable serving of consumable 24, for instance, is configured to hold at least about 150 milliliters (about five fluid ounces), and, in one embodiment, at least about 350 milliliters (about twelve fluid ounces) or more of consumable 24.

In one embodiment, end wall 12 and side wall 14 are formed as a single piece in an injection molded process. For example, end wall 12 and side wall 14 may be formed of a plastic-based material such as acrylic, acrylonitrile butadiene styrene (ABS), polyvinyl chloride (PVC), polyethylene (PE), high density polyethylene (HDPE), polypropylene (PP), polyurethane, thermoplastic urethane, etc. Such materials can be used in any suitable manner to create any form stored-value vessel 10, which in one embodiment, is specifically configured for housing one or more particular types of consumable 24. For example, where stored-value vessel 10 is expected to receiving at least one of a hot or cold beverage or other hot or cold consumable 24, end wall 12 and/or side wall 14 may be formed with insulative properties (i.e., properties to decrease the rate of temperature change of consumable 24 toward an ambient or environmental temperature). In one embodiment, one or both of end wall 12 and side wall 14 are formed in a dual-paneled, thick wall, or other suitable manner, as will be apparent to those of skill in the art upon reading the present application, to increase the insulative properties of stored-value vessel 10.

Other variations in the shape, form, or other properties of stored-vessel 10 are also contemplated. For example, as illustrated in FIG. 1, stored-value vessel 10 includes a handle 30 to facilitate the consumer in grasping or otherwise manipulating stored-value vessel 10. In one embodiment, other grip enhancing features such as grooved side features, rubberized features, etc. (not shown) may be included in or attached to side wall 14 as an alternative or in addition to handle 30 or no grip enhancing features may be included on stored-value vessel 10. In one example, end wall 12 may also be formed with friction enhancing properties to decrease the likelihood that stored-value vessel 10 will inadvertently topple over or otherwise slide off of a support surface.

In one embodiment, stored-value vessel 10, more particularly, side wall 14, defines a rim 32 or other structure about opening 22 configured to selectively receive a removable lid 34. For example, as illustrated in FIG. 1, lid 34 includes a substantially planar portion or main panel 36 sized and shaped similarly to opening 22 of side wall 14 (e.g., shaped in a circular manner). A flange 38 extends around main panel 36 and is configured to fit around and couple with rim 32 of side wall 14 in a friction fit or other suitable manner. As such, lid 34 substantially covers opening 22, which decreases the likelihood that any consumable 24 contained therein will be inadvertently spilled or dispensed. In one example, an aperture 40 is formed in main panel 36 of lid 34 to allow consumable 24 to be removed from chamber 20 while lid 34 is coupled with side wall 14. Other forms of stored-value vessels are also contemplated. For example, stored-value vessel 10 may be shaped as a bowl, plate, or other suitable container.

In one example, stored-value vessel 10 includes at least one account activation area or account identifier 60, such as a bar code, a magnetic strip, a smart chip or other electronic device, a radio frequency identification (RFID) device, or other suitable identifier readily machine readable by a point-of-sale terminal, account access station, kiosk, or other suitable device. In one embodiment, account identifier 60 is also readable by a bearer of stored-value vessel 10 such that stored-value vessel 10 can be used when a machine configured to read stored-value vessel 10 is not present (e.g., when using stored-value vessel 10 to make a purchase on a web site), is having technical difficulties, or is otherwise unavailable. For example, account identifier 60 may include a number or letter string identifying the associated account or record and/or a password (not illustrated) associated therewith. In one example, account identifier 60 additionally or alternatively includes a number string for use as a password or personal identification number (PIN) configured to provide additional securing to the user of stored-value vessel 10. In one embodiment, account identifier 60 is printed on or otherwise applied to second or outside surface 62 of side wall 14 and/or is secured to another portion of stored-value vessel 10. For instance, account identifier 60 may be applied to end wall 12 as illustrated in FIG. 2.

Account identifier 60 indicates and, therefore, links stored-value vessel 10 to, a financial, stored-value or other account or record. In one embodiment, the account or record indicates a value or balance (e.g., financial balance, point balance, minute balance, or other balance) associated with stored-value vessel 10 and optionally is maintained on a database, other electronic or manual record-keeping system, or, in the case of “smart” cards for example, on a chip or other electronic device on/in stored-value vessel 10 itself. Accordingly, by scanning account identifier 60, the account or record linked to stored-value vessel 10 is identified and can subsequently be activated, have value debited therefrom, and/or have value credited thereto. Account identifier 60 is one example of means for linking stored-value vessel 10 with an account or record.

Although stored-value vessel 10 is primarily described throughout this application for use similar to a gift card, phone card, etc., in one embodiment, stored-value vessel 10 is configured for inventory tracking in addition or as an alternative to providing means for pre-payment of goods and/or services. In such embodiments, stored-value vessel 10 functions as an inventory tracking mechanism. For example, the value associated with the account or record linked to stored-value vessel 10 via account identifier 60 may indicate the total amount of consumables that have been filled into stored-value vessel 10. Such an account or record allows the retailer or vendor to track the inventory or amount of total consumables 24 consumed by the bearer of stored-value vessel 10. Such a system may be useful, for example, to alcoholic or other vendors who may want to limit the amount of a particular consumable 24 consumed by a bearer as a whole or within a particular time frame.

In one embodiment, the value of the account or record may be a time value. Where the account or record indicates a time value, inventory may be tracked or controlled in situations where a purchased stored-value vessel 10 may be repeatedly refilled with or without additional cost, but only for a limited amount of time. For example, a movie theater may offer stored-value vessel 10 filled with popcorn with unlimited refills, but only for a 6 hour or other suitable time period. Use of account identifier 60 linked with the account or record allows the movie theater to police such refills and discourage consumers from attempting to fill stored-value vessel 10 with popcorn after the offer has expired. Other suitable inventory tracking uses of stored-value vessel 10 will be apparent to those of skill in the art upon reading the present application.

In one embodiment, redemption indicia 64 are included on stored-value vessel 10 such as on outside surface 62 of side wall 14. Redemption indicia 64 indicate that stored-value vessel 10 is redeemable toward the purchase of goods and/or services (i.e., functions as a pre-paid or other stored-value card). In one embodiment, redemption indicia 64 include phrases such as “This GiftCard is redeemable for merchandise or services at any of our stores or at our web site,” and/or provide help or phone line information in the case of a lost, stolen, or damaged stored-value card, etc. In one embodiment, redemption indicia 64 include information regarding what merchants accept stored-value vessel 10 as payment toward goods and/or services and/or other instructions for activation, redemption, loading, etc.

Other indicia or additional features may also be included on stored-value vessel 10 as will be apparent to those of skill in the art upon reading this application. For example, brand indicia 66 may be applied to or otherwise may be visible from outside surface 62 of side wall 14. In one embodiment, brand indicia 66 identify a store, brand, department, etc. and/or services associated with stored-value vessel 10 and may include one or more of a store name, store logo, brand name, brand logo, department name, department logo, etc. In one embodiment, brand indicia 66 are linked to one or more merchants or outlets configured to accept stored-value vessel 10 or, more particularly, to accept value from the account or record linked to stored-value vessel 10 toward the payment for goods and/or services. In one example, any one or more of redemption indicia 64 and brand indicia 66 may not be included on stored-value vessel 10.

In one embodiment, account identifier 60, redemption indicia 64 and/or brand indicia 66 are printed to a substantially planar label 80 that is subsequently coupled with side wall 14. In particular, in one example, label 80 is formed of a similar material as side wall 14 and defines first, second, third and forth edges 82, 84, 86 and 88, respectively. First and second edges 82 and 84 are spaced from one another and each extend in a substantially linear manner. Third and fourth edges 86 and 88 each extend between first and second edges 82 and 84 opposite and substantially parallel to one another in a curvilinear manner. In one example, third edge 86 is substantially longer than fourth edge 88. As such, label 80 is configured to be wrapped around side wall 14 of stored-value vessel 10 in a substantially smooth manner. In one embodiment, label 80 is sized such that first edge 82 abuts or overlaps second edge 84 when label 80 is placed around side wall 14.

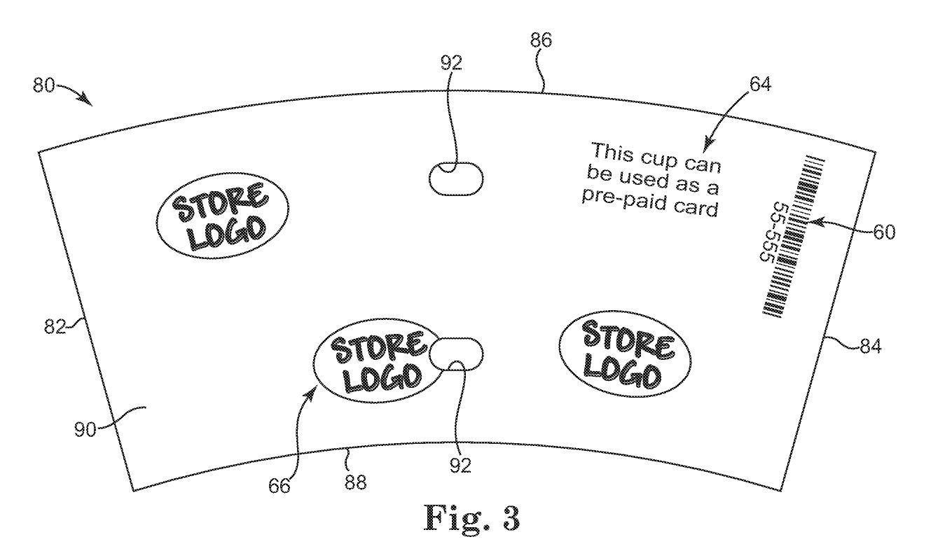

More specifically, label 80 defines a first surface 90 (e.g., FIG. 3) and a second surface (not shown) opposite first surface 90 each bounded by first, second, third and fourth edges 82, 84, 86 and 88. The second surface of label 80 is configured to interface with or otherwise be positioned closest to side wall 14. Label 80 is one of opaque, transparent, and translucent. In one embodiment, account identifier 60, redemption indicia 64 and/or brand indicia 66 are printed or otherwise applied to first surface 90 of label 80.

In one embodiment, for example, where label 80 is one of translucent and transparent, account identifier 60, redemption indicia 64 and/or brand indicia 66 are reverse printed to the second surface of label 80. As such, account identifier 60 is interposed or embedded between side wall 14 and label 80 such that that account identifier 60, redemption indicia 64 and/or brand indicia 66 can be viewed and suitably read through first surface 90 of label 80. In one example, reverse printing account identifier 60, redemption indicia 64 and/or brand indicia 66 to the second surface of a transparent or translucent label 80, increases the durability of account identifier 60, redemption indicia 64 and/or brand indicia 66 since account identifier 60, redemption indicia 64 and/or brand indicia 66 are not directly exposed to the environment but rather are positioned between the remainder of label 80 and side wall 14.

A more durable account identifier 60 allows stored-value vessel 10 to be exposed to an increased number of wash and reuse cycles while still providing the necessary functionality required to access the associated account or record. In one embodiment, stored-value vessel 10 is configured to undergo over seventy-five, and in one embodiment, over one hundred, wash and reuse cycles, whether via hand washing or using a dishwashing machine, without substantially degrading account identifier 60, for example, degrading account identifier 60 such that account identifier 60 cannot be mechanically read (i.e., substantially destroying the readability of account identifier) or such that account identifier 60 otherwise no longer functions in a reliable manner. Other printing, application, or other suitable methods of increasing the longevity of account identifier 60 are also contemplated.

In one embodiment, label 80 is formed with additional features as will be apparent to those of skill in the art upon reading the present application. For instance, label 80 may be formed with internal apertures 92 to facilitate coupling or formation of handle 30 or other grip enhancing member to or on side wall 14.

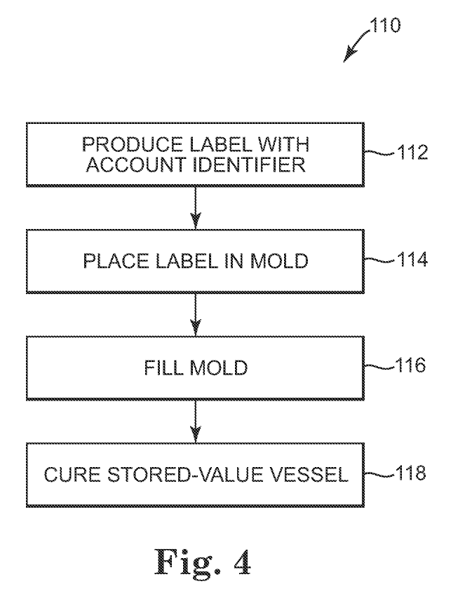

FIG. 4 is a flow chart illustrating a method 110 of forming stored-value vessel 10, according to one embodiment of the present invention. Method 110, as described below, forms stored-value vessel 10 using in-mold labeling technology. However, it should be understood that other suitable methods of forming stored-value vessel 10 are also contemplated.

In-mold label technology takes advantage of electrostatic precipitation or vacuum absorbing principles and allows label(s) 80 to be produced at 112 in a substantially flat or planar form. More specifically, in one embodiment, label 80 is formed in a curvilinear manner as described above with respect to FIG. 3, and is sized to fit around a substantial entirety of side wall 14. In one embodiment, account identifier 60, redemption indicia 64 and/or brand indicia 66 are printed to one or both of first surface 90 and the second surface (not shown) of label 80. In one example, items printed to the second surface are reverse printed and configured to be viewed through first surface 90 of label 80 where label 80 is one of transparent and translucent. In one embodiment, since label 80 is produced in a flat manner, account identifiers 60 can more easily be applied to each label 80, where each account identifier 60 is differentiated from other account identifiers 60 applied to other labels 80. In one example, where account identifier 60 includes a bar code or other printable identifier, the substantially planar label 80 is easily printed using available techniques, which solves the difficulties of printing on a rounded or non-planar surface such as directly to side wall 14 of stored-value vessel 10.

At 114, each label 80 produced at 112 is placed within a mold for forming stored-value vessel 10. In one embodiment, where handle 30 is to be included on stored-value vessel 10, label 80 is positioned in the mold such that apertures 92 align with an expected boundary between handle 30 and side wall 14. Label 80 is general held in place within the mold using electrostatic or vacuum forces. In one embodiment, an additional label (not shown) may be positioned within label to couple with end wall 12 or other portion of stored-value vessel 10.

Once label 80 is properly positioned within the mold, then, at 116, mold is injected or otherwise filled with a suitable material (e.g., plastic) to form end wall 12, side wall 14 and/or any other moldable features such as handle 30. Following injection at 116, label 80, which, in one embodiment, is formed of a similar plastic as used to fill the mold, is fused with side wall 14, as will be apparent to those of skill in the art upon reading the present application. At 118, stored-value vessel 10 is cured, if necessary, to fix stored-value vessel 10 in its desired form. Following construction, account identifier 60 is rigidly coupled or immovable secured to one or more of end wall 12 and side wall 14. It should be understood, that while primarily described above as being applied using in-mold technology, label 80 may otherwise be coupled with side wall 14 with adhesive or in any other suitable manner. In one embodiment, account identifier is additionally or alternatively embossed or otherwise formed in one or more of end wall 12 and side wall 14.

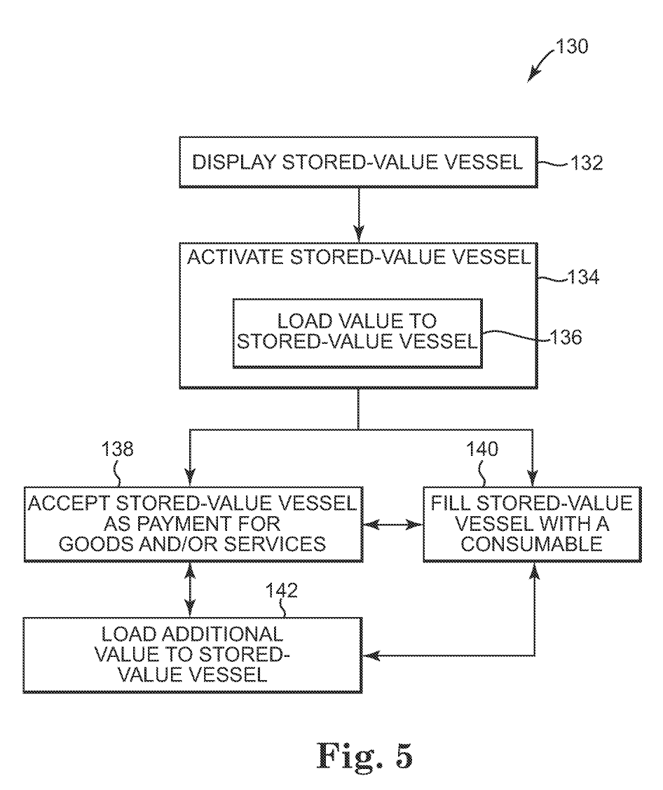

FIG. 5 is a flow chart illustrating one embodiment of a method 130 of encouraging purchase and facilitating use of stored-value vessel 10 by consumers and/or recipients. At 132, stored-value vessel 10 is placed on display for sale to potential consumers. In one embodiment, a depiction of stored-value vessel 10 is placed on a web site for viewing and purchase by potential consumers.

At 134, a consumer, who has decided to purchase stored-value vessel 10, presents stored-value vessel 10 to a merchant employee, kiosk, remote terminal, or other person or device adapted to scan account identifier 60 and to access the account or record linked to account identifier 60. In particular, account identifier 60 is scanned or otherwise accessed to activate stored-value vessel 10. In one example, activation stored-value vessel 10 is performed when stored-value vessel 10 is sold or otherwise provided to consumer. In one embodiment, upon accessing the account or record, then, at 136, value is added to the account or record in the form of monetary value, points, minutes, etc. Thus, stored-value vessel 10 is activated and loaded. In one embodiment, a predetermined value is associated with stored-value vessel 10 prior to activation. As such, upon activation, the predetermined value is available for use toward purchases and operation 136 is eliminated.

Once stored-value vessel 10 is activated and loaded, stored-value vessel 10 can be used by the consumer or any other bearer of stored-value vessel 10 to purchase goods and/or services at the affiliated merchant (e.g., a retail store or web site) or can be used in exchange for calling minutes, etc. In one embodiment, where stored-value vessel 10 is displayed on a web site at 132, then, at 134, stored-value vessel 10 may be activated in any suitable method and may not require the physical scanning of account identifier 60 to be activated or to otherwise access the associated account or record such as at 136.

In one example, at 138, the retail store or other affiliated retail setting or web site accepts stored-value vessel 10 as payment toward the purchase of goods and/or services made by the current bearer of stored-value vessel 10. In particular, the value currently loaded on stored-value vessel 10 (i.e., stored or recorded in the account or record linked to account identifier 60) is applied toward the purchase of goods and/or services. In one example, at 138, stored-value vessel 10 is applied toward the purchase of consumable 24, and then, during or following the purchase, stored-value vessel 10 is filled with the purchased consumable 24 at 140. Stored-value vessel 10 may be applied toward the purchase of goods and/or services not configured to be maintained within stored-value vessel 10 and/or may be used to contain other consumables or products not purchased from the merchant using stored-value vessel 10.

At 142, additional value is optionally loaded on stored-value vessel 10 at a point-of-sale terminal, kiosk, web site or other merchant-related site. Upon accepting stored-value vessel 10 as payment at 138 and/or filling stored-value vessel 10 at 140, the merchant can subsequently perform either operation 138 or operation 142 as requested by a current bearer of stored-value vessel 10. Similarly, upon loading additional value on stored-value vessel 10 at 142, the merchant can subsequently perform either operation 142 again or perform one or more of operations 138 and 140. In one example, the ability of a merchant to accept stored-value vessel 10 as payments for goods and/or services at 138 is limited by whether the account or record associated with stored-value vessel 10 has any value stored or recorded therein at the time of attempted redemption.

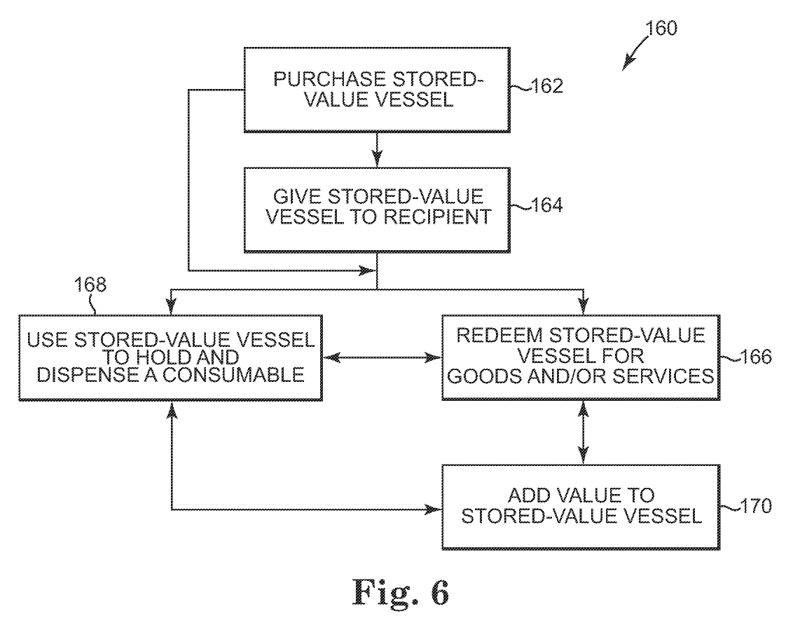

FIG. 6 is a flow chart illustrating one embodiment of a method 160 of using stored-value vessel 10 (e.g., FIGS. 1 and 2). At 162, a potential consumer of stored-value vessel 10, which is displayed by a merchant, decides to and does purchase stored-value vessel 10 from the merchant. Upon purchasing stored-value vessel 10, a merchant employee, a store kiosk, or other person or device scans account identifier 60 or otherwise reads or accesses account identifier 60. Upon accessing account identifier 60, the account or record linked to account identifier 60 is accessed and activated to load value onto stored-value vessel 10 (i.e., load value to the account or record associated with stored-value vessel 10). In one embodiment, such as where stored-value vessel 10 is purchased at 162 via a web site, actual scanning or other mechanical detection of account identifier 60 may be eliminated.

At 164, the consumer optionally gives stored-value vessel 10 to a recipient, such as a graduate, employee, relative, friend, expectant parents, one having a recent or impending birthday, a couple having a recent or impending anniversary, etc. In one embodiment, a plurality of stored-value vessels 10 are purchased and given to party goers, such as at a birthday party, etc. as party favors or gifts. As an alternative, the consumer can keep stored-value vessel 10 for his or her own use thereby eliminating operation 164.

At 166, the consumer or recipient redeems stored-value vessel 10 for goods and/or services such as consumable 24 from the merchant. Accordingly, the value of the goods and/or services is deducted from the account or record associated with the stored-value vessel 10. In one embodiment, during redemption of stored-value vessel 10 toward the purchase of consumable 24, stored-value vessel 10 is also filled with consumable 24. For example, where consumable 24 is coffee or other beverage, the consumer may fill stored-value vessel 10 with consumable 24 and then proceed to the point-of-sale terminal to purchase consumable 24 with stored-value vessel 10. In one embodiment, the consumer orders and purchases consumable 24 at the point-of-sale terminal, and a merchant employee subsequently fills stored-value vessel 10 with the purchased consumable. In this manner, the dual use of stored-value vessel 10 simplifies the sale or purchase transaction process by eliminating the exchange of a payment vehicle separate from stored-value vessel 10 being used to receive consumable 24. Accordingly, the time required to complete a sale is reduced, which benefits both the consumer and the merchant. Following purchase at 166, then, at 168, stored-value vessel 10 is used to hold and dispense consumable 24 (e.g., holds the coffee and allows the bearer of stored-value vessel 10 to drink the coffee from chamber 20.

At 170, the consumer or recipient of stored-value vessel 10 optionally adds value to stored-value vessel 10, more particularly, to the account or record associated with account identifier 60 included therewith, at a merchant-related site. Upon using stored-value vessel 10 to hold consumable 24 at 168, redeeming stored-value vessel 10 at 166 or adding value to stored-value vessel 10 at 170, the consumer or recipient of stored-value vessel 10 subsequently can perform either of operations 166, 168 or 170 as desired. In one embodiment, the ability of the consumer or recipient to repeat redeeming stored-value vessel 10 at 166 is limited by whether the account or record linked with stored-value vessel 10 has any remaining value stored or recorded therein at the time of attempted redemption.

Although described above as occurring at a single merchant site, in one embodiment, purchasing stored-value vessel 10 at 162, redeeming stored-value vessel 10 at 166, and adding value to stored-value vessel 10 at 170, can each be performed at any one of a number of merchant-related stores adapted to accept stored-value vessel 10 or over the Internet such as via a merchant-related web site. In one example, a number of stores are each part of a chain or are similarly branded stores associated with a merchant. In one example, a number of stores include at least one web site and/or at least one conventional brick and mortar store.

Stored-value vessels come in many forms, according to embodiments of the invention and can be “re-charged” or “re-loaded” at the direction of the original consumer, a gift recipient, or a third party. The term “loading on” or “loaded on” herein should be interpreted to include adding to the balance of an account or record associated with the stored-value vessel. The balance associated with the stored-value vessel declines as the stored-value vessel is used, encouraging repeat visits or use. The stored-value vessel remains available to the consumer for use in holding consumables other than those purchased from the merchant, serving as an advertisement or a reminder to revisit the associated merchant. Stored-value vessels according to embodiments of the invention provide a number of advantages to both the consumer and the merchant including increased ease of use and faster purchase transaction times. Other stored-value vessels according to embodiments of the invention function similarly to loyalty cards, merchandise return cards, electronic gift certificates, calling cards, employee cards, frequency cards, prepaid cards, and other types of stored-value cards associated with or representing purchasing power, monetary value, etc.

Although the invention has been described with respect to particular embodiments, such embodiments are meant for illustrative purposes only and should not be considered to limit the invention. Various alternatives and changes will be apparent to those of ordinary skill in the art. Other modifications within the scope of the invention and its various embodiments will be apparent to those of ordinary skill.

What is claimed is:

1. A stored-value vessel comprising:
an end wall,
a side wall extending around and away from the end wall to define a chamber therebetween, wherein the chamber is configured to repeatedly receive one or more products for consumption by a bearer of the stored-value vessel; and
an account identifier readily machine readable by a point-of-sale terminal and immovably included on at least one of the end wall and the side wall, the account identifier linking the stored-value vessel to an account or record such that the stored-value vessel is configured to facilitate use of the stored-value vessel as one of payment toward a purchase of one or more of goods and services and an inventory tracking mechanism.

2. The stored-value vessel of claim 1, wherein the account identifier is a bar code.

3. The stored-value vessel of claim 2, wherein the account identifier is one of a bar code, a magnetic strip, a smart chip and a radio frequency identification (RFID) device.

4. The stored-value vessel of claim 1, wherein the account identifier is included on a label coupled with the side wall.

5. The stored-value vessel of claim 4, wherein the label is coupled with the side wall using in-mold label technology.

6. The stored-value vessel of claim 4, wherein the account identifier is printed to the label.

7. The stored-value vessel of claim 6, wherein the label is one of translucent and transparent, and the account identifier is reverse printed to a surface of the label adjacent the side wall.

8. The stored-value vessel of claim 1, wherein the side wall is insulated.

9. The stored-value vessel of claim 1, further comprising a handle coupled with and extending from the side wall.

10. The stored-value vessel of claim 1, wherein the side wall defines an opening to the chamber, and the stored-value vessel further includes a lid selectively coupled with the side wall to substantially cover the opening to the chamber.

11. The stored-value vessel of claim 1, wherein the end wall is circular, and the side wall tapers outwardly as the side wall extends away from the end wall.

12. The stored-value vessel of claim 1, wherein the chamber is sized to hold the volume of the consumable of at least about 150 milliliters.

13. The stored-value vessel of claim 1, wherein the stored-value vessel is configured to withstand a plurality of wash and reuse cycles without degrading functionality of the account identifier.

14. The stored-value vessel of claim 1, further comprising one of the one or more products maintained within the chamber.

15. The stored-value vessel of claim 1, wherein one of a inventory time value and an inventory amount value is associated with the account or record.

16. A vessel comprising:
an end wall,
a side wall extending around and away from the end wall to define a chamber therebetween, wherein the chamber is sized to hold a volume of a consumable of at least about 150 milliliters therein; and
an account identifier readily machine readable by a point-of-sale terminal and immovably included on at least one of the end wall and the side wall, the account identifier linking the vessel to an account or record such that the vessel is configured to facilitate use of the stored-value vessel as one of payment toward a purchase of one or more of goods and services and an inventory tracking mechanism.

17. A transaction cup comprising:
means for selectively maintaining a consumable, wherein the means for selectively maintaining the consumable is reusable; and
means for linking the means for selectively maintaining the consumable with at least one of an account and a record having a value associated therewith such that the means for selectively maintaining the consumable can be used as one of payment toward a purchase of the consumable and an inventory tracking mechanism, wherein the means for linking is configured to withstand a plurality of wash and reuse cycles while the means for linking is coupled with the means for selectively maintaining without substantially decreasing readability of the means for linking.

18. The transaction cup of claim 17, wherein the means for linking is interposed between the means for selectively maintaining the consumable and a label applied to the means for selectively maintaining the consumable.

19. The transaction cup of claim 17, wherein the means for selectively maintaining the consumable is insulated.

20. The transaction cup of claim 17, wherein the means for linking is applied to a label securely coupled with the means for selectively maintaining the consumable.

21. The transaction cup of claim 17, wherein the plurality of wash and reuse cycles includes at least seventy-five wash and reuse cycles.

22. A method of facilitating purchase of a consumable using a stored-value vessel, wherein the stored-value vessel includes an activation area, which links the stored-value vessel to an account or record having an associated financial balance, the method comprising:
accessing the account or record by reading the activation area from a side wall of the stored-value vessel;
accepting at least a portion of the financial balance associated with the account or record toward a purchase of the consumable; and
filling the stored-value vessel with the consumable.

23. The method of claim 22, further comprising selling the stored-value vessel to a consumer prior to accessing the account or record, accepting at least the portion of the financial balance associated with the account or record, and filling the stored-value vessel with the consumable.

24. The method of claim 22, wherein the activation area is immovably secured to the side wall of the stored-value vessel.

25. The method of claim 22, wherein filling the stored-value vessel with the consumable includes filling the stored-value vessel with at least about five ounces of the consumable.
